(19) United States
(12) Patent Application Publication
(10) Pub. No.: US 2008/0225166 A1
(43) Pub. Date: Sep. 18, 2008

(54) Audio-video apparatus

(75) Inventors: Hironari Kawai, Hamamatsu-shi (JP); Yoshiaki Tsutsui, Hamamatsu-shi (JP); Masaya Kanoh, Hamamatsu-shi (JP); Tatsuya Takahashi, Hamamatsu-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 12/012,633

(22) Filed: Feb. 5, 2008

(30) Foreign Application Priority Data
Feb. 7, 2007 (JP) P2007-027867

(51) Int. Cl. H04N 3/27; H04N 7/00

(52) U.S. Cl. 348/554; 348/844

(57) ABSTRACT

An audio-video apparatus, which is connectable to a plurality of external devices (e.g., DVD players, TV monitors, and game devices) so as to process input signals thereof and to thereby control them individually, stores a plurality of packaged information regarding setups and operations, i.e., a plurality of scene templates, which are assigned to a plurality of scene buttons in advance. When the user presses a desired scene button, the corresponding scene template is called and read out so as to automatically realize prescribed setup and operation in connection with a desired external device. The audio-video apparatus allows the user to edit and customize scene templates assigned to the scene buttons in association with messages indicating details of scene templates, which are visually displayed on the screen.

### BACKGROUND OF THE INVENTION

1. Field of the Invention

The present invention relates to audio-video (AV) apparatuses for use in home systems, such as audio-video amplifiers and audio-video receivers.

This application claims priority on Japanese Patent Application No. 2007-27867, the content of which is incorporated herein by reference.

2. Description of the Related Art

Audio-video apparatuses for use in home theater systems, such as audio-video amplifiers and audio-video receivers, are connectable to various types of playback apparatuses and recording-playback apparatuses, such as DVD players, digital TV tuners, cable TV tuners, satellite broadcasting tuners, CD players, record players, and DVD recorders, and are individually designed to realize various functions for playing back various types of digital media such as DVD-Video, CD, DVD-Audio, SACD (Super Audio CD), and Video-CD.

Conventionally-known audio-video apparatuses are designed based on operating systems allowing users to appropriately select input terminals (or to appropriately select interconnected devices). That is, the user of a conventionally-known audio-video apparatus selects (or switches) a desired device so as to produce a desired sound (or a desired video) and also selects a desired sound-field effect to be applied to the selected sound (or selected video).

Conventionally-known audio-video apparatuses are also equipped with well-known functions such as favorite functions, in which preset values, which were frequently used in the past, are stored in advance and are then instantaneously read out and set up; and system memory functions, in which various default values (or preset values) and sound-field programs are stored in advance and are then read out with simple operation.

Japanese Unexamined Patent Application Publication No. 2002-142278 discloses a device control method that allows the user to read out preset functions and parameters with one key operation.

According to the aforementioned device control method, the user manually operates a remote control device so as to select (or switch) an input source and a surround mode and to adjust frequency characteristics of a graphic equalizer and an electronic volume, so that user setup instructions are stored and are then read out upon manual operations on keys, whereby desired parameters are assigned to the user's setup instructions.

Conventionally-known audio-video apparatuses are each accompanied with a user instruction manual, which is very thick in volume so as to describe technical explanations regarding interconnections with various devices and which also describes user setup controls and operations (regarding functions allowing the user to watch movies on DVDs, etc.) by way of fragmentary explanations, which are difficult for the user to search and read.

For this reason, the user who purchases a conventionally-known audio-video apparatus experiences difficulty in reading the user instruction manual to find out user setup controls and operations, which the user wishes to read, due to fragmentary explanations and numerous functions installed in the audio-video apparatus. This takes a long time for the user to grasp user setup controls and operations suited to the user's preference. In addition, once the user sets up the audio-video apparatus in control and operation, it is troublesome for the user (and anyone of the user's family) to restore the audio-video apparatus to an original setup and operation; hence, the user and other family members experience difficulty in appropriately setting up the conventionally-known audio-video apparatus, which is not designed in a user-friendly manner and in an easy-to-handle manner.

Favorite functions are related to fragmentary setup values, which are stored with respect to specific functions, channels, and stations; hence, they are not directly suited to the user's preference which the user wishes to realize desired functions in the system.

System memory functions are each designed to simply store setup conditions of the system; hence, each of them needs a relatively large storage capacity. In addition, every user may set up different contents to be stored in a memory, so that unnecessary contents (or fixed and unchanged contents) must be stored in a memory and recalled unnecessarily. That is, every user differs from each other in user's preference contents, which the user wishes to store in a memory, and in user's non-preference contents, which the user does not wish to store in a memory; hence, it is very difficult to understand a distinction between user's preference contents and user's non-preference contents with respect to every user. Some conventionally-known audio-video apparatuses are designed to present edit menus allowing users to edit stored contents of memories, wherein every user performs editing by selecting necessary items and parameters from among the stored contents of a memory; in other words, only a highly-skilled person or a high-intelligence person can appropriately set up and edit the stored contents of a memory, but a beginner or a poor-skilled person cannot set up and edit the stored contents of a memory.

The device control method disclosed in Japanese Unexamined Patent Application Publication No. 2002-142278 may allow the user to simultaneously set up plural items and parameters with simple key operations in the audio-video apparatus. However, this device control method is basically similar to the conventionally-known technology handling the favorite function and system memory function because it is designed to request the user to set up and select parameters and functions suited to the user's preference and then to store them in a memory. That is, the aforementioned device control method still requires the user to learn detailed knowledge in setting up and selecting parameters and functions in advance.

### SUMMARY OF THE INVENTION

It is an object of the present invention to provide an audio-video apparatus, which is not designed in particular for a person who is familiar with detailed instructions and operations and who can easily set up and recall parameters and functions but which allows a beginner or a user who does not have detailed information about instructions and operations to easily handle and to realize desired functions with simple manual operations.

In a first aspect of the present invention, an audio-video apparatus, which is connectable to a plurality of external devices so as to process input signals and to thereby control the external devices individually, includes a memory for storing a plurality of packaged information, each of which includes information regarding setup and operation in connection with each of the external devices, a selector for selecting desired packaged information from among the packaged information stored in the memory, and a control section for controlling at least one of the external devices based on the desired packaged information, which is selected by the selector. The selector is constituted of a plurality of manual operable members, each of which is assigned with the packaged information that has a high frequency in usage in advance, wherein the control section allows the user to customize the packaged information preset to each of the manual operable members. The audio-video apparatus further includes a second memory for storing new packaged information, which is produced by editing the packaged information stored in the memory by the user and which is assigned to a desired manual operable member instead of the packaged information previously assigned thereto.

In a second aspect of the present invention, an audio-video apparatus (e.g., an audio-video receiver), which is connectable to a plurality of external devices so as to process input signals and to thereby control the external devices individually, includes a signal processor for processing input signals supplied from a desired external device, an input switch for switching and selecting the desired external device from among the external devices, a memory for storing a plurality of scene templates, each of which includes information regarding setup and operation in connection with each of the plurality of external devices, a plurality of scene buttons, which are assigned with the scene templates in advance, and a control section for controlling the signal processor and the input switch in such a way that, when the user operates a desired scene button, a scene template assigned to the desired scene button is applied to the input signal supplied from the desired external device. The audio-video apparatus further includes a display for displaying a message under control of the control section, wherein the control section allows the user to edit and customize the scene template preset to the desired scene button with reference to the message indicating details of the scene template. Each of the scene templates is configured by a plurality of items with regard to a prescribed scene to be realized in connection with each of the external devices, so that the control section allows the user to selectively change the items so as to customize the scene template.

In the above, the audio-video apparatus provides the user with numerous pieces of packaged information (i.e., scene templates) having high frequencies in usage with regard to setups, functions, and operations, wherein the user is required to simply press a desired manual operable member, e.g., a desired scene button which is arranged in an easily-accessible area, so as to immediately and institutively realize a desired scene with respect to input signals supplied from a desired external device (e.g., a DVD player). Since prescribed setups regarding scenes are already examined and evaluated, it is possible for the user to easily realize a desired scene based on the optimum setup. This eliminates the necessity that the user must read user manual instructions so as to learn difficult setups and operations before the user actually operates the audio-video apparatus. Herein, the scene templates having high frequencies in usage are assigned to the scene buttons in advance.

For example, when the user wishes to watch a movie on a DVD, the user simply presses a desired scene button so as to automatically realize a series of setups and operations such as zone setup, input selection, sound-field setup, night listening mode setup, and playback of the DVD on the basis of the scene template assigned thereto.

The audio-video apparatus allows the user to easily edit and customize scene templates assigned to scene buttons; hence, it is possible for the user to assign favorite scene templates, which the user regularly use, to easily-accessible scene buttons, thus reliably and easily reproducing favorite scenes.

In addition, when the user customizes favorite scene templates, which are then registered and assigned to desired scene buttons, it is possible for the user to call and execute favorite setups upon one-button pressing. Herein, the audio-video apparatus provides the user with numerous scene templates subjected to editing and customization. This reduces the total number of parameters (or items) subjected to editing and customization; hence, the user who does not have detailed information regarding setups and operations of the audio-video apparatus is capable of simply changing the least-minimum number of parameters, thus appropriately editing and customizing the scene templates without difficulty.

Furthermore, since new packaged information (or new scene data) that the user creates based on preset scene templates is stored in the memory (e.g., a RAM) in advance, it is possible to reduce the capacity of the memory; hence, the present invention can be realized using an inexpensive microcomputer, thus reducing the cost for realization of the audio-video apparatus.

### BRIEF DESCRIPTION OF THE DRAWINGS

These and other objects, aspects, and embodiments of the present invention will be described in more detail with reference to the following drawings, in which:

FIG. 1 is a block diagram showing the overall constitution of an audio-video apparatus, i.e., an audio-video receiver, in accordance with a preferred embodiment of the present invention;

FIG. 2 is a front view showing the exterior appearance of the audio-video receiver;

FIG. 3 is a front view showing a layout of keys arranged on the surface of a remote control device;

FIG. 4 is a state transition diagram showing state transition between NON-SCENE CALL, SCENE CALL, SCENE CHANGE, and SCENE CUSTOMIZATION;

FIG. 5A shows an example of messages displayed on a TV monitor connected to the audio-video receiver;

FIG. 5B shows an example of messages displayed on a main display of the audio-video receiver in relation to FIG. 5A;

FIG. 5C shows an example of messages displayed on the TV monitor;

FIG. 5D shows an example of messages displayed on the main display of the audio-video receiver in relation to FIG. 5C;

FIG. 6 is a flowchart showing a series of setups and operations in connection with user manual instructions after purchase of the audio-video receiver;

FIG. 7 is a block diagram showing interconnections of blocks in the audio-video receiver for realization of a scene entitled “Watch DVD Movie”;

FIG. 8 is a flowchart showing. a series of setups and operations in accordance with a simple routine operation allowing the user to listen to a music CD;

FIG. 9 is a block diagram showing interconnections of blocks in the audio-video receiver for realization of a scene entitled “Listen CD Using DVD Player”;

FIG. 10 is a block diagram showing interconnections of blocks in the audio-video receiver for realization of a scene entitled “Play Game”;

FIG. 11 is a block diagram showing interconnections of blocks in the audio-video receiver for realization of a scene entitled “Listen Regular FM Program in Second Room”;

FIG. 12 is a flowchart showing the processing of SIMPLE SCENE ASSIGN together with a table showing examples of scenes preinstalled in the audio-video receiver;

FIG. 13A shows an example of messages displayed on the TV monitor in connection with a mode of SCENE CHANGE;

FIG. 13B shows an example of messages displayed on the main display of the audio-video receiver in relation to FIG. 13A;

FIG. 13C shows an example of messages displayed on the TV monitor in connection with the mode of SCENE CHANGE;

FIG. 13D shows an example of messages displayed on the main display of the audio-video receiver in relation to FIG. 13C;

FIG. 13E shows an example of messages displayed on the TV monitor in connection with the mode of SCENE CHANGE;

FIG. 13F shows an example of messages displayed on the main display of the audio-video receiver in relation to FIG. 13E;

FIG. 14 is a flowchart showing the processing of SCENE DETAILS CUSTOMIZE;

FIG. 15A shows an example of messages displayed on the TV monitor in connection with a mode of SCENE CUSTOMIZATION;

FIG. 15B shows an example of messages displayed on the main display of the audio-video receiver in relation to FIG. 15A;

FIG. 15C shows an example of messages displayed on the TV monitor in connection with the mode of SCENE CUSTOMIZATION;

FIG. 15D shows an example of messages displayed on the main display of the audio-video receiver in relation to FIG. 15C;

FIG. 15E shows an example of alert messages displayed on the TV monitor in the mode of SCENE CUSTOMIZATION;

FIG. 15F shows an example of alert messages displayed on the main display in relation to FIG. 15E;

FIG. 16 shows the relationship between preset scene templates and scene templates customized by the user; and

FIG. 17 shows an example of messages displayed upon SCENE CHANGE and SCENE CUSTOMIZATION.

### DESCRIPTION OF THE PREFERRED EMBODIMENT

The present invention will be described in further detail by way of examples with reference to the accompanying drawings.

First, technical terms for use in the explanation of the present invention are defined as follows:

The term “scene” represents a method or manner how to use an audio-video apparatus by the user, in other words, a way of operation that the user wishes to realize using the audio-video apparatus (e.g., listening to a CD and watching a movie on a DVD).

The term “scene data” represents “packaged information” (or composite information) for collectively packaging various setups (e.g., necessary setups, necessary operations, and links with interconnected external devices) in order to realize “scenes”. Herein, “necessary setups” indicates sound-field setups, setups of night-listening modes (i.e., functions for not allowing large sound to be produced in prescribed time zones), and setups of surround modes; “necessary operations” indicate power-on, zone switching, volume adjustment, selection of input sources, audio-select switching (or selection of input modes), and mute releasing; and “links with interconnected external devices” indicates power control of interlinked (or interconnected) DVD players and controlling of playback of DVDs, for example.

The term “scene template” indicates “scene data” that is stored in the system in advance. That is, the present invention allows the user to customize scene templates so as to create individual scene data.

The present invention is applicable to various types of audio-video apparatuses, i.e., products of home theater systems. The following description is given with respect to an audio-video receiver in accordance with the present invention.

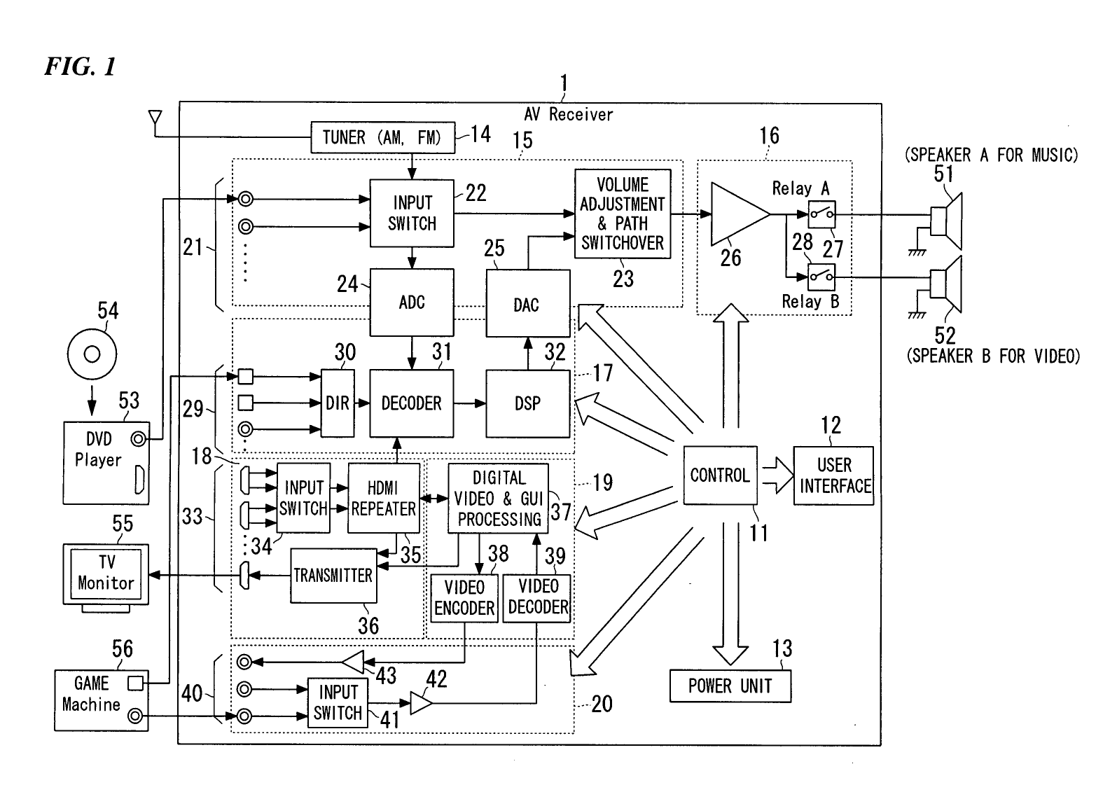

FIG. 1 is a block diagram showing the overall constitution of an audio-video receiver 1 in accordance with a preferred embodiment of the present invention.

In FIG. 1, reference numeral 11 designates a control section for performing overall control on various sections of the audio-video receiver 1; reference numeral 12 designates a user interface including manual-operable members and a remote-control receiver; reference numeral 13 designates a power unit; and reference numeral 14 designates a tuner for receiving AM signals and FM signals. The control section 11 includes a CPU, a ROM for storing control programs and scene templates, and a RAM for storing various data such as user customized data and scene data.

Reference numeral 15 designates an analog audio signal processor including analog audio input terminals 21, an input switch 22, and a volume adjustment and path switchover section 23 as well as an A/D converter (ADC) 24 and a D/A converter (DAC) 25 that are used for interconnection with a digital audio signal processor 17. The input switch 22 delivers input signals from the analog audio input terminals 21 and the tuner 14 to the volume adjustment and path switchover section 23 and the A/D converter 24.

Reference numeral 16 designates a power amplifier unit including a power amplifier 26, and relays 27 and 28 (referred to as “Relay A” and “Relay B”) that are connected to speakers 51 and 52 respectively.

Reference numeral 17 designates a digital audio signal processor including digital audio input terminals 29, a digital audio interface receiver (DIR) 30 for inputting signals from the digital audio input terminals 29, a decoder 31, a digital signal processor (DSP) 32 for performing various types of processing such as sound-field addition, speaker adjustment, and environmental correction (or environmental compensation). The decoder 31 decodes multichannel signals from the analog-to-digital converter 24, the digital audio interface receiver 30, or an HDMI repeater 35 (which will be described below) so as to output decoded results to the digital signal processor 32. The output of the digital signal processor 32 is converted into analog signals by means of the digital-to-analog converter 25. Analog signals are supplied to the volume adjustment and path switchover section 23.

Reference numeral 18 designates a digital interface including high-definition multimedia interface (HDMI) terminals 33, an input selector 34, and a transmitter 36 as well as the HDMI repeater 35. Signals input by the HDMI terminals 33 are supplied to the HDMI repeater 35 via the input selector 34. The HDMI repeater 35 outputs digital audio signals (i.e., multichannel signals) to the decoder 31. In addition, the HDMI repeater 35 delivers video signals to the HDMI terminals 33 via the transmitter 36, whereby video signals are supplied to an external device such as a monitor.

Reference numeral 19 designates a digital video signal processor including a digital video and GUI (graphical user interface) processing section 37, a video encoder 38, and a video decoder 39. The digital video and GUI processing section 37 is connected to the HDMI repeater 35, the transmitter 36, the video encoder 38, and the video decoder 39. The digital video and GUI processing section 37 performs prescribed processing on signals output from the HDMI repeater 35 and the video decoder 39; then, it outputs processing results to the HDMI repeater 35, the transmitter 36, and the video encoder 38.

Reference numeral 20 designates an analog video signal processor including analog video input/output terminals 40, an input switch 41, and buffer amplifiers 42 and 43. Analog video signals input by the analog video input terminal 40 are supplied to the video decoder 39 via the input switch 41 and the buffer amplifier 42. The output of the video encoder 38 is supplied to the analog video output terminal 40 via the buffer amplifier 43; then, it is output to an external device.

The audio-video receiver 1 of FIG. 1 also includes various sections (not shown) for use in realization of playback using a second speaker (not shown) set to a second zone or room (e.g., a kitchen), such as a second-zone input switch, a second-zone volume adjustment and path switchover section, a second-zone power amplifier, and a second-zone relay.

A control section 11 controls various constituent elements of the audio-video receiver 1 based on operation signals of external devices such as an operation panel and a remote control device adapted to the audio-video receiver 1 and based on setup information included in combination information (e.g., sequence templates and sequence data), which is recalled as described below.

Specifically, the control section 11 performs various controls on the user interface 12, the power unit 13, the tuner 14, the analog audio signal processor 15, the power amplifier unit 16, the digital audio signal processor 17, the digital interface 18, the digital video signal processor 19, and the analog video signal processor 20.

Specifically, the control section 11 performs operation control, reception of remote control signals, and display control on the user interface 12. The control section 11 performs protection control, power on/off control, and mode control on the power unit 13.

In addition, the control section 11 controls the tuner 14. With respect to the analog audio signal processor 15, the control section 11 performs input switch control on the input switch 22 and volume control and path control on the volume adjustment and path switchover section 23.

With respect to the power amplifier unit 16, the control section 11 performs on/off control of the relays 27 and 28. The control section 11 also supplies a control signal to the power amplifier 26 so as to perform output control.

Furthermore, the control section 11 supplies various control signals to the digital audio signal processor 17 so as to perform input selection control, path control, sound-field decoding control, and sound field and environmental correction control. With respect to the digital interface 18 and the digital video signal processor 19, the control section 11 outputs control signals so as to perform video signal processing control, input switch control, path control, GUI menu control, and HDMI control.

With respect to the analog video signal processor 20, the control section 11 outputs control signals so as to perform input switch control and path control.

The audio-video receiver 1 having the aforementioned constitution is connectable to various external devices such as speakers, DVD players, CD players, DVD recorders, digital TV tuners, cable TV tuners, and game devices.

In FIG. 1, output terminals of a DVD player 53, which is capable of playing back a digital recording media 54 (e.g., a CD and a DVD), are connected to the analog audio input terminal 21 and the HDMI terminal 33 respectively. Another HDMI terminal 33 is connected to a television monitor 55. Output terminals of a game device (or a game machine) 56 are connected to the digital audio input terminal 29 and the analog video input terminal 40 respectively.

The first relay 27 of the power amplifier unit 16 is connected to a first speaker 51 (referred to as a speaker A) for use in music appreciation, and the second relay 28 is connected to a second speaker 52 (referred to as a speaker B) for use in video (or movie) appreciation.

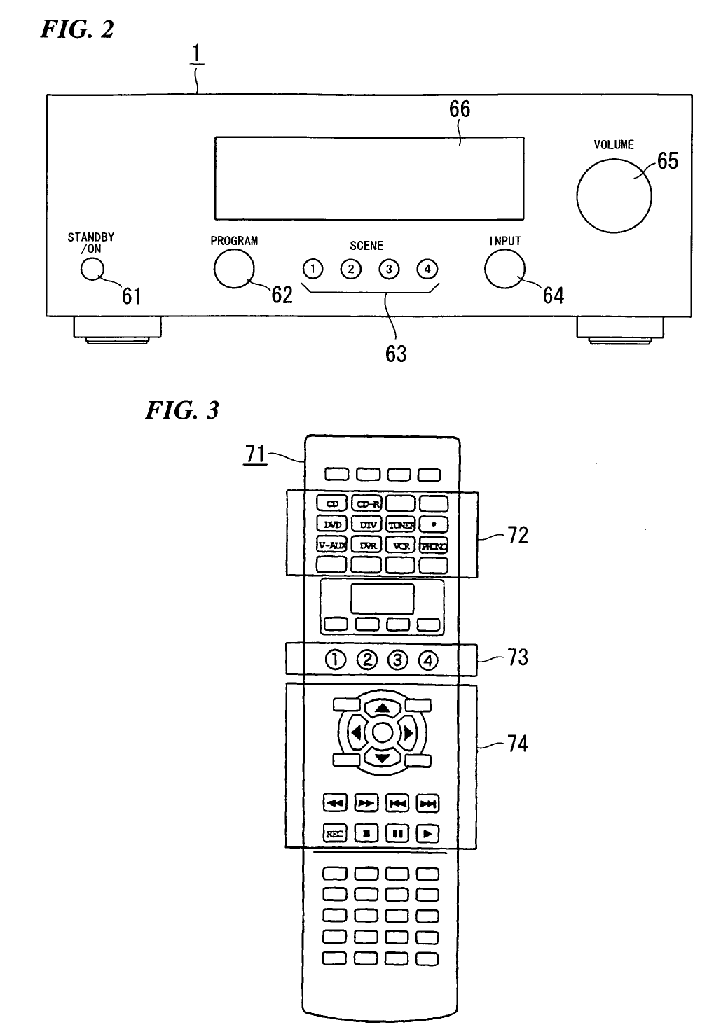

FIG. 2 is a front view showing the exterior appearance of the audio-video receiver 1.

In FIG. 2, reference numeral 61 designates a STANDBY/ON switch for switching over power-on and standby; reference numeral 62 designates a program selector (or a “PROGRAM SELECT” switch) allowing the user to select sound-field programs; reference numeral 63 designate scene buttons to which scene data are assigned; reference numeral 64 designates an input selector (or an “INPUT SELECT” switch) allowing the user to select input sources; reference numeral 65 designates a volume control; and reference numeral 66 designates a main display. In a standby mode, power is supplied to the CPU and the remote-control receiver (see the control section 11 and the user interface 12 shown in FIG. 1).

Specifically, four scene buttons 63 are collectively arranged in an easily-accessible area of the front face of the audio-video receiver 1, wherein they are assigned with serial numbers “1” to “4” and are equipped with LEDs respectively. That is, when the user presses a certain scene button 63, the corresponding LED is turned on so as to visually illuminate the corresponding scene number (i.e., “1” to “4”).

The aforementioned manual operable members are allocated to the user interface 12, so that they produce operation signals when they are manually operated; then, operation signals are supplied to the control section 11, which in turn correspondingly outputs control signals to constituent elements of the audio-video receiver 1 so as to realize desired control suited to user's manual operation.

FIG. 3 shows a layout of keys arranged on the surface of a remote control device 71.

In FIG. 3, reference numeral 72 designates input selection buttons (or “INPUT SELECT” buttons) allowing the user to select input sources (referred to as DVD, CD, etc.); reference numeral 73 designates scene buttons (which are arranged in conformity with the scene buttons 63 of the audio-video receiver 1); and reference numeral 74 designates operation buttons (referred to as scan keys, PLAY, SKIP, etc.) allowing the user to operate an external device interconnected to the audio-video receiver 1. Herein, prescribed functions are assigned to the operation buttons 74 in correspondence with scene data selected by the user.

The four scene buttons 73 are collectively arranged in an easily-accessible area of the surface of the remote control device 71 and are assigned with serial numbers “1” to “4” in correspondence with the four scene buttons 63 of the audio-video receiver 1.

The number of the scene buttons 63 and the number of the scene buttons 73 are not necessarily limited to four and are each set to an arbitrary number.

As shown in FIGS. 2 and 3, both the scene button 63 and the scene button 73 assigned with the same serial number are assigned with same scene data. That is, both the scene buttons 63 and the scene buttons 73 are designed to execute prescribed functions in conformity with each other.

In the audio-video receiver 1, a plurality of scene templates are stored in the ROM in advance, wherein four scene templates having high frequencies in usage are assigned to the four scene buttons 63 respectively. This allows the user to select desired operation to be realized on the audio-video receiver 1. This function will be referred to as “SCENE CALL”.

For example, when the user watches a movie on a DVD, the user simply presses a desired scene button 63 (or 74) which is assigned with a desired scene template, whereby a series of necessary information and setups are automatically read from the scene template with respect to various operations such as zone setup, power control, input switch, sound-field setup, night listening mode setup, and DVD playback, which are thus appropriately executed.

That is, the user can easily realize desired scenes (or preset scenes) after purchase of the audio-video receiver 1 having the remote control device 71.

As the user is accustomed to the operation (or as the user repeatedly operates the audio-video receiver 1 for a relatively long time), the user may intend to change scene templates preset to the scene buttons 63 (or 73). The audio-video receiver 1 allows the user to change scene templates preset to the scene buttons 63; this function will be referred to as “SIMPLE SCENE ASSIGN”.

As the user is further accustomed to the detailed operation, the user may not satisfy preset scene templates, which the manufacturer prepares and sets up in advance, so that the user may demand to create new scene data suited to the user's preference. The audio-video receiver 1 allows the user to customize scene templates so as to create new scene data, which are then assigned to the scene buttons 63; this function will be referred to as “SCENE CUSTOMIZATION”.

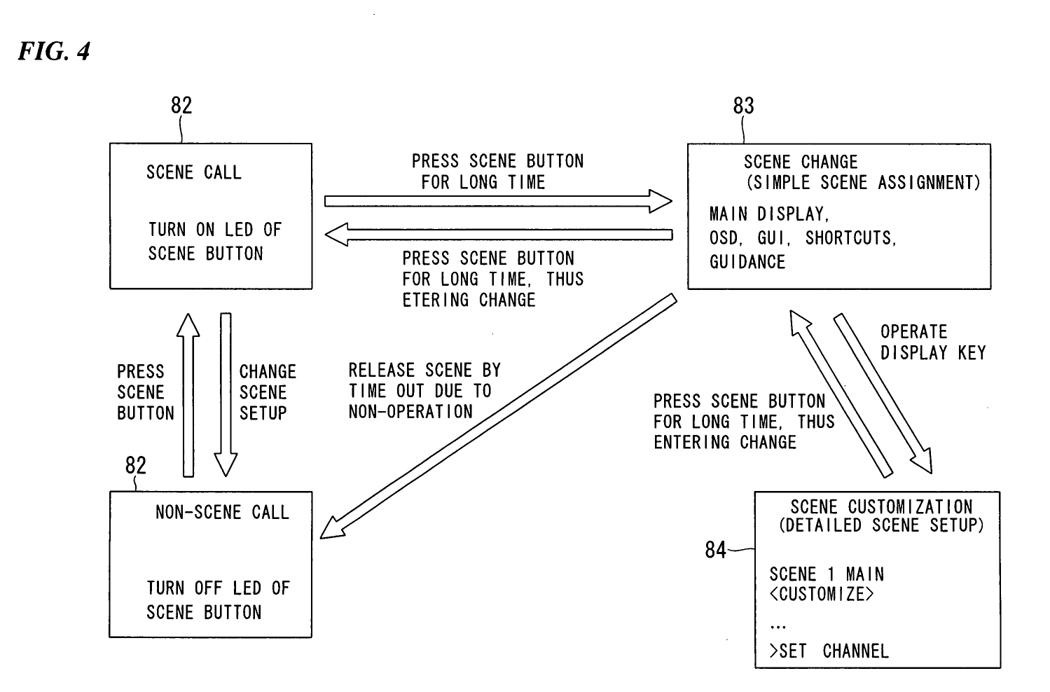

FIG. 4 shows state transition between various modes referred to as SCENE CALL, SIMPLE SCENE ASSIGN, and SCENE CUSTOMIZATION.

When no scene button 63 (or 73) is operated, the audio-video receiver 1 is set to a mode 81 of NON-SCENE CALL, in which all the LEDs of the scene buttons 63 are turned off. When the user presses a desired scene button 63 (or 73) in the mode 81, transition occurs from the mode 81 to a mode 82 of SCENE CALL, in which the corresponding scene data are called and read out. That is, the control section 11 reads various setup data and operation data included in the scene data from the memory so as to supply them to the corresponding processor.

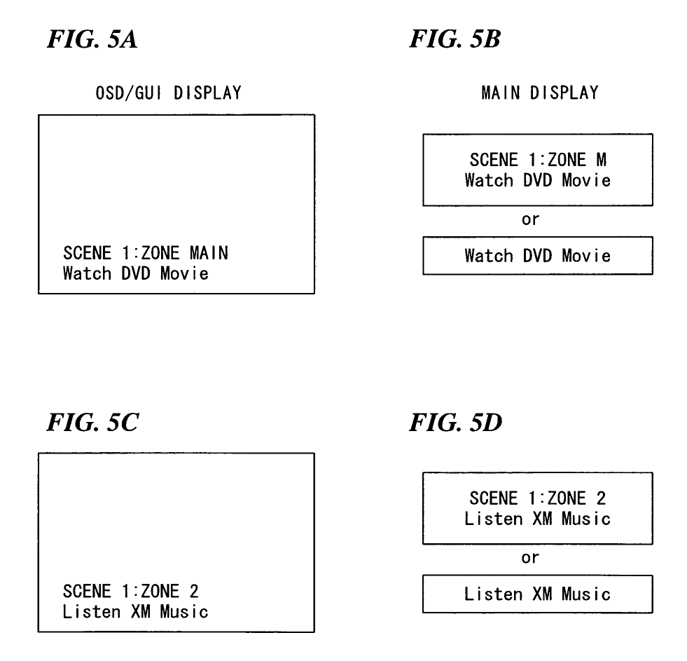

FIGS. 5A to 5D show examples of messages being displayed by way of the user interface 12 when the audio-video receiver 1 is set to the mode 82 of SCENE CALL upon depression of the scene button 63 (or 73). Herein, FIGS. 5A and 5C show examples of messages displayed on the TV monitor 55 (which is connected to the audio-vide receiver 1) by way of on-screen display (OSD) or by way of OSD/GUI display in which the user operates the graphical user interface (GUI). FIGS. 5B and 5D show examples of messages displayed on the main display 66 of the audio-video receiver 1.

FIGS. 5A to 5D show examples of messages that are displayed on the TV monitor 55 and the main display 66 of the audio-video receiver 1 when the user presses the scene button 63 (or 73) assigned with the serial number “1”, which is assigned with a scene template entitled “Watch DVD Movie”, for example. That is, when the user presses the scene button “1”, a scene name “Watch DVD Movie” is displayed on the TV monitor 55 (see FIG. 5A) and on the main display 66 (see FIG. 5B). It is possible to set up a multi-zone function having a second speaker, which is arranged in a second room (designated by “ZONE 2”) that differs from the room arranging the audio-video receiver 1 (designated by “ZONE MAIN” or “ZONE M”), to play back sound. In this case, a scene name “Listen XM Music”, which is assigned to the scene button “1” in connection with ZONE 2, is displayed on the TV monitor 55 (see FIG. 5C) and on the main display 66 (see FIG. 5D) instead of the aforementioned scene name assigned in connection with ZONE MAIN (or ZONE M). As described above, the audio-video receiver 1 has the multi-zone function, which allows different scene data to be assigned to each scene button in connection with different zones.

When a prescribed time elapses in the mode 82 of SCENE CALL, the OSD/GUI display is stopped on the TV monitor 55, but the scene name is continuously displayed on the main display 66 as shown in FIGS. 5B and 5D.

The present embodiment is not designed to use formal names such as “DVD INPUT” but to use user-friendly and easy-to-comprehend scene names such as “Watch DVD Movie”, “Listen HiFi Disc”, “Listen HiFi CD”, and “Enjoy Radio”, which are words representing actual operations preferred by the user, in other words, which are words representing specific operations that the user wishes to realize, wherein these scene names are determined based on audio and video media and based on contents of media subjected to playback. This allows the user to easily select desired scene templates.

In the mode 82 of SCENE CALL, when the user operates the audio-video receiver 1 so as to change setups relating to the called scene data, transition occurs from the mode 82 to the mode 81. For example, when the user operates some switches or buttons so as to select another input device (or another media) irrespective of the called scene data so that setups relating to the called scene data are changed and the corresponding scene template is no longer used, the audio-video receiver 1 is returned to the mode 81 of NON-SCENE CALL.

Alternatively, when the user continuously presses a certain scene button 63 (or 73) so that a prescribed time (e.g., ten seconds) elapses in the mode 82 of SCENE CALL, transition occurs from the mode 82 to a mode 83 of SCENE CHANGE (alternatively referred to as SIMPLE SCENE ASSIGN). That is, when the user continuously presses a certain scene button 63 (or 73) so as to change the assigned scene template, the audio-video receiver 1 is set to the mode 83 of SCENE CHANGE, in which the LED of the scene button being continuously pressed is repeatedly turned on and off (or blinks). In this state, the user operates the remote control device 71 using scan keys (e.g., a right-scan key and a left-scan key) while watching the main display 66 or the OSD/GUI display, thus selecting a desired scene template to be newly assigned to the scene button 63 (or 73). Details of the mode 83 of SCENE CHANGE will be described later.

After completion of selection of a desired scene template, the user presses the scene button 63 (or 73) again so as to enter the change; then, transition occurs from the mode 83 of SCENE CHANGE to the mode 82 of SCENE CALL. When a prescribed time (e.g., thirty seconds) elapses without no manual operation in the mode 82 of SCENE CALL, transition occurs from the mode 82 to the mode 81.

When the user presses a specific key (e.g., a DISPLAY key, not shown) of the remote control device 71 within a prescribed time (e.g., ten seconds) counted in the mode 83 of SCENE CHANGE, transition occurs from the mode 83 to a mode 84 of SCENE CUSTOMIZATION (alternatively referred to as “DETAILED SCENE SETUP” or “DETAILED SCENE CUSTOMIZATION”). In the mode 84 of SCENE CUSTOMIZE, the audio-video receiver 1 allows the user to customize an original scene template so as to create new scene data, which is then assigned to a desired scene button 63 (or 73). The details thereof will be described later.

After completion of DETAILED SCENE SETUP, when the user presses the scene button 63 (or 73) again or when the user operates the audio-video receiver 1 so as to select “ENTER” in MENU (not shown), the audio-video receiver 1 is returned to the mode 83 of SCENE CHANGE. Then, the foregoing transitions occur from the mode 83 to the mode 82 or from the mode 83 to the mode 81.

Next, details of the aforementioned modes 81 to 84 will be described in connection with SCENE CALL, SIMPLE SCENE ASSIGN, and DETAILED SCENE CUSTOMIZATION.

### 1. Scene Call

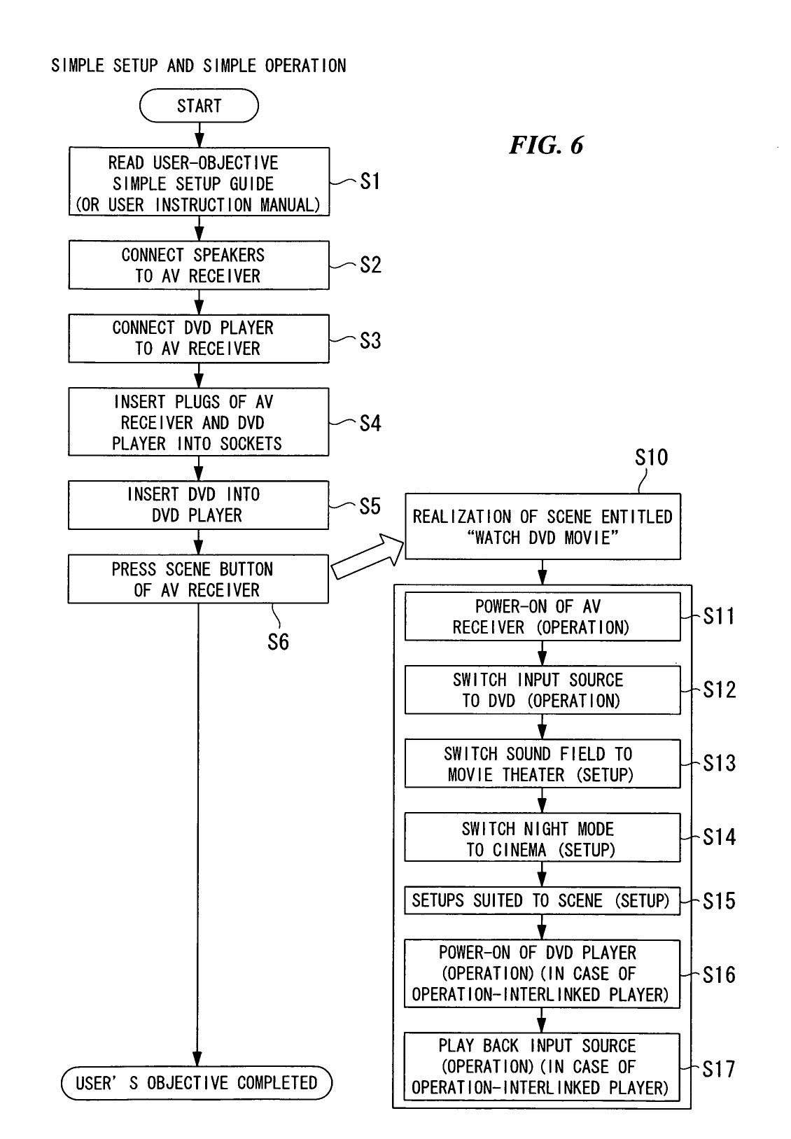

FIG. 6 is a flowchart showing a series of setups and operations in connection with user manual instructions after purchase of the audio-video receiver 1, which is referred to as “SIMPLE SETUP AND SIMPLE OPERATION”.

After purchase of a product of the audio-vide receiver 1, the user searches over user-objective simple setup guides (or user instruction manuals) included with the product so as to read an explanation regarding a desired operation that the user wishes to realize on the product first in step S1. The user-objective simple setup guides differ from conventional “thick” user instruction manuals in that a single manual instruction form representing a single usage manner describes specific explanations with regard to connections with external devices and methods how to press scene buttons in connection with a user's objective, whereby the user can easily realize the user's objective by pressing a prescribed scene button at last. The following description is given with respect to a specific user's objective, in which the user wishes to watch a movie on the DVD player 53. In this case, the user selects a simple setup guide regarding “Watch DVD Movie” in step S1. Of course, other simple setup guides regarding “Listen CD”, “Listen FM”, “Watch TV”, etc., which may have high frequencies in customer's usage, are prepared and preinstalled in the audio-video receiver 1 in advance. Default values representing scene templates regarding the aforementioned simple setup guides are assigned to the scene buttons 63 and 73 in connection with serial numbers “1” to “4” in advance.

In accordance with the simple setup guide, the user connects the speakers 51 and 52 to the audio-video receiver 1 in step S2; the user connects the DVD player 53 to the audio-video receiver 1 in step S3; then, the user inserts plugs of power cords of the audio-video receiver 1 and the DVD player 53 into sockets for supplying power in step S4. The simple setup guide describes a least-minimum-required connection allowing the user to watch a movie on a DVD, whereby it is possible for the user to establish necessary connection realizing playback of the contents of DVDs.

Next, the user inserts a DVD into the DVD player 53 in step S5. In accordance with the simple setup guide, the user presses a scene button 63 (or 73) (e.g., a scene button “1”), which is assigned with a scene template entitled “Watch DVD Movie”, in step S6. Then, the flow proceeds to step S10 in which the scene “Watch DVD Movie” is realized under control of the control section 11.

Specifics of the step S10 will be described with reference to steps S11 to S17 shown in FIG. 6. The control section 11 applies electric power to the audio-video receiver 1 in step S11; it switches connection with the DVD player 53 in step S12; it switches the sound field to “Movie Theater” in step S13; it switches the night listening mode (referred to as “Night Mode”) to “Cinema” in step S14; and it controls various setups suited to the scene template. When the DVD player 53 interconnected to the audio-video receiver 1 is an operation-interlinked type allowing the audio-video receiver 1 to control it, the control section 11 applies electric power to the DVD player 53 in step S16. In step S17, the control section 11 controls the DVD player 53 to play back an input source (e.g., a DVD).

As described above, the audio-video receiver 1 of the present embodiment allows the user to watch (or listen to) the contents of a DVD by simply pressing a desired scene button 63 (or 73).

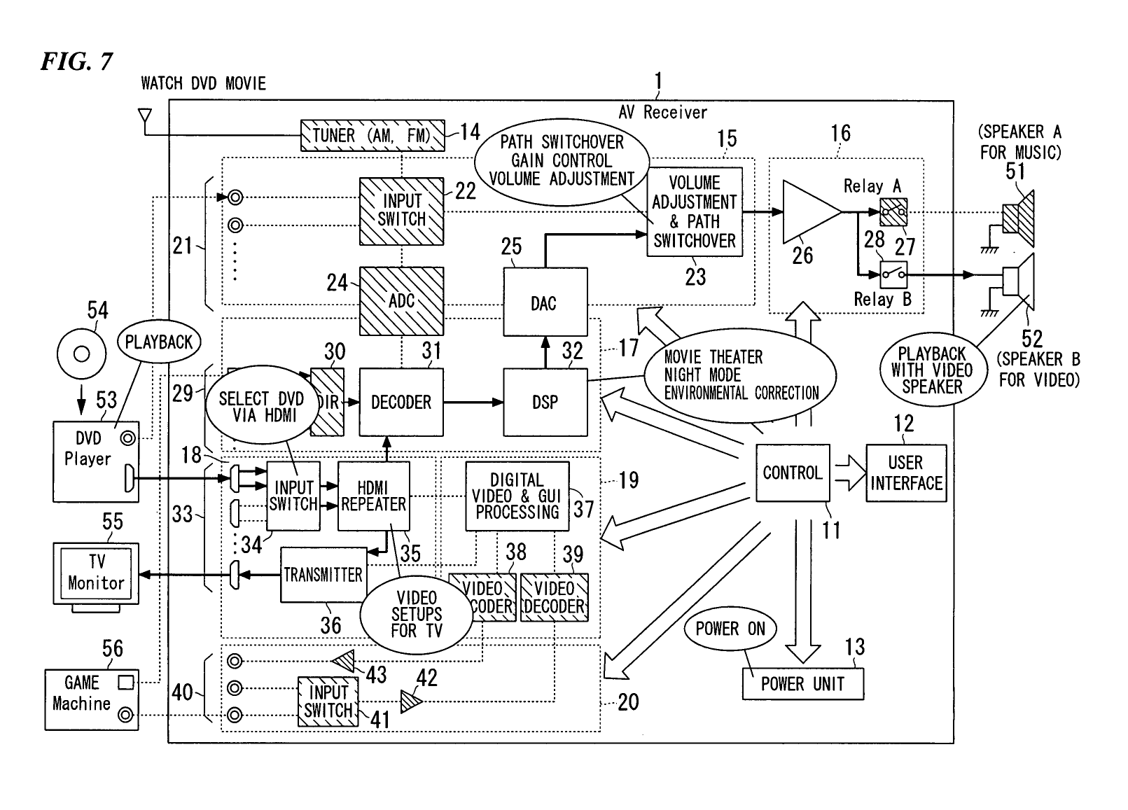

FIG. 7 is a block diagram showing interconnections of blocks in the audio-video receiver 1 for realization of the scene entitled “Watch DVD Movie”.

In FIGS. 7, 9, 10, and 11, roughly-hatched blocks are deactivated in functions thereof, so that signals flow through bold lines; and comments appended to blocks represent operations each automatically performed with a single press of the corresponding scene button 63 (or 73).

In FIG. 7, power is turned on with respect to the power unit 13 of the audio-video receiver 1; an input source (i.e., the DVD player 53) is selected via the HDMI terminal 33 by means of the input switch 34; a playback mode is set to “Movie Theater” sound field; the night listening mode is turned on; video signals are output to the TV monitor 55; the electronic volume is adjusted based on a desired value; then, sound is reproduced using the speaker 52 for movies. In addition, prescribed functions for use in playback of the DVD player 53 are set to the operation buttons 74 of the remote control device 71.

As described above, the present embodiment is designed to automatically select connection, operation, and setup required for realization of a desired scene by the user who simply selects and presses a single scene button 63 (or 73). This makes it unnecessary for the user to memorize specific setups of functions to perform troublesome operations.

In addition, the present embodiment allows the user to easily watch (or listen to) movies on DVDs in accordance with optimum setups recommended by the manufacturer in conformity with conditions of scenes.

The audio-video receiver 1 of the present embodiment provides the user with a simple setup guide describing a series of operations with regard to connections with external devices and realization of scenes, in other words, it rapidly provides the user with specifics regarding simple setups and actual operations in usage. In normal usage, the user does not necessarily read a thick user instruction manual but can watch a movie on a DVD after purchase of the audio-video receiver 1.

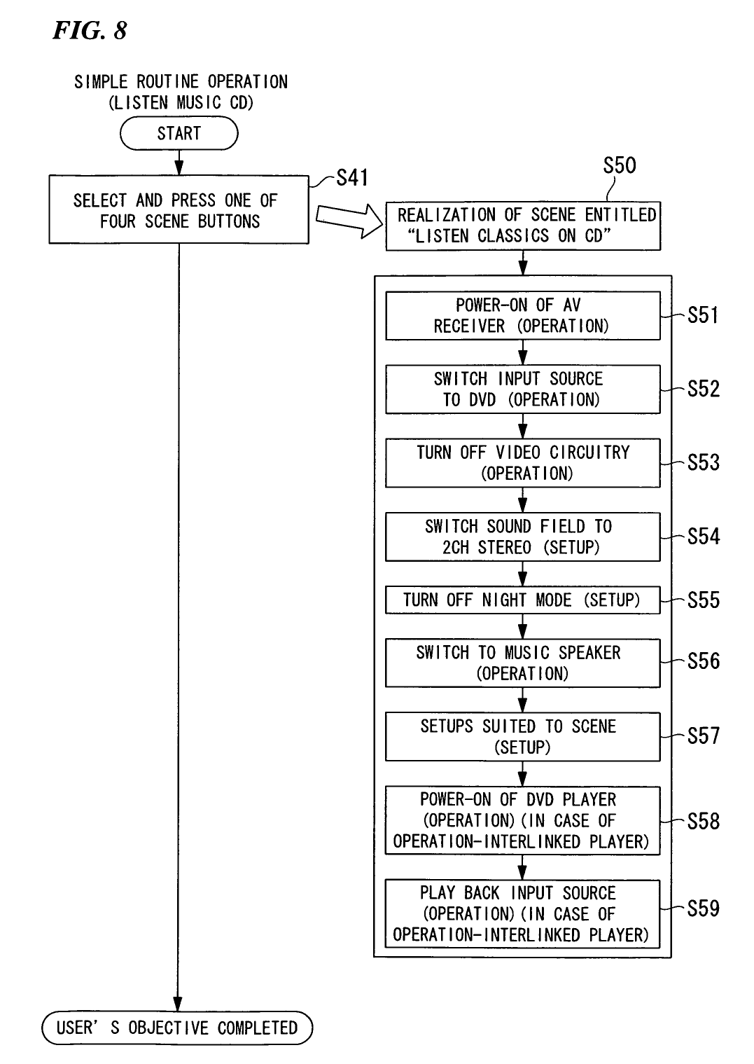

FIG. 8 is a flowchart showing an example of a simple routine operation in which the user listens to a CD by use of a scene button 63 (or 73), wherein a CD is already set in the DVD player 53.

First, the user presses a scene button 63 (or 73) which is assigned with a scene template representing a scene entitled “Listen CD” or “Listen CD Using DVD Player” in step S41; hence, the flow proceeds to step S50 in which the scene “Listen CD Using DVD Player” is realized. Specifics of the step S50 will be described with reference to steps S51 to S59. That is, power is turned on with respect to the audio-video receiver 1 in step S51; an input source is switched to a DVD (i.e., the analog audio input terminal 21 is connected to the DVD player 53) in step S52; power is turned off with respect to the video circuitry (i.e., the digital interface 18, the digital video signal processor 19, and the analog video signal processor 20) in step S53; the sound field is set to “2ch Stereo” in step S54; the night listening mode (Night Mode) is turned off in step S55; the audio-video receiver 1 switches connection to the speaker 51 for music in step S56; other setups suited to the desired scene are set to the audio-video receiver 1 in step S57; when the DVD player 53 interconnected to the audio-video receiver 1 is an operation-interlinked type, power is turned on with respect to the DVD player 53 in step S58; and an input source (i.e., a CD) is played back in step S59.

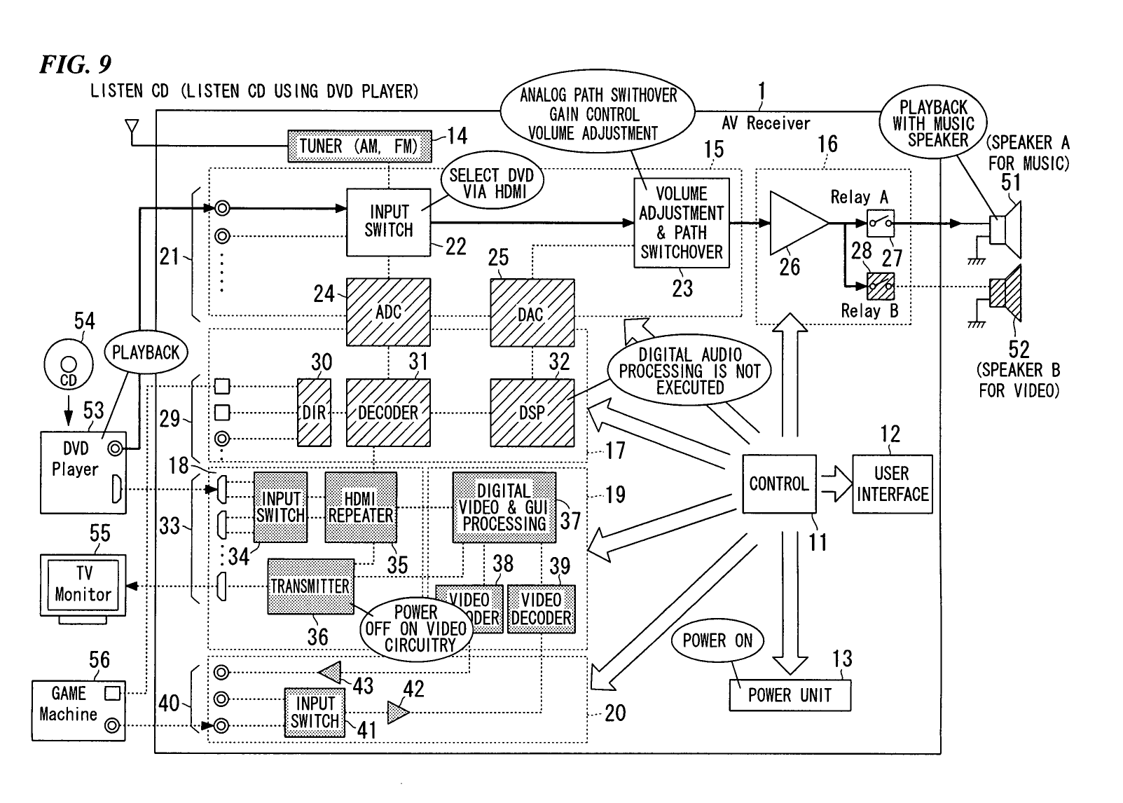

FIG. 9 is a block diagram showing interconnections of blocks in the audio-video receiver 1 for realization of the scene entitled “Listen CD Using DVD Player”. In FIG. 9, electric power is turned off with respect to dark-hatched blocks (i.e., the tuner 14, the digital interface 18, and the digital video signal processor 19). When the user presses a scene button 63 (or 73) assigned with the aforementioned scene, power is turned on with respect to the audio-video receiver 1; the DVD player 53 is used; an input source (i.e., a DVD) is selected via the analog audio input terminal 21 by way of the input switch 22; a playback mode is set to “Pure Direct Mode”; the night listening mode is turned off; power is turned off with respect to the video circuitry; the electronic volume is adjusted to a desired value by way of the shortest analog path; then, the speaker 51 reproduces sound. In the “Pure Direct Mode”, electric power is turned off with respect to the unnecessary circuitry so that the user can enjoy music having a good quality without causing unnecessary load in processing. In addition, functions relating to the playback of the DVD player 53 are assigned to the operation buttons 74 of the remote control device 71.

Thus, the user can enjoy high-quality music by a simple operation, i.e., pressing a desired scene button 63 (or 73).

FIG. 10 is a block diagram showing interconnections of blocks in the audio-video receiver 1 for realization of a scene entitled “Play Game” when the user presses a scene button 63 (or 73) assigned with a scene template entitled “Play Game”.

In the above, power is turned on with respect to the audio-video receiver 1; a game media is inserted into the game device 56; an input source (i.e., a game) is selected via the digital audio input terminal 29 by means of the digital audio interface receiver 30; a playback mode is set to the sound field of “Action Game”; video signals are supplied to the TV monitor 55 via the HDMI terminal 33; the night listening mode is turned off; the electronic volume is set to a desired value; then, the speaker 52 reproduces sound for video.

As described above, the game device 56 is connected to the audio-video receiver 1; then, the user simply presses the scene button 63 (or 73) assigned with the aforementioned scene template, thus appropriately setting up the audio-video receiver 1 to play games.

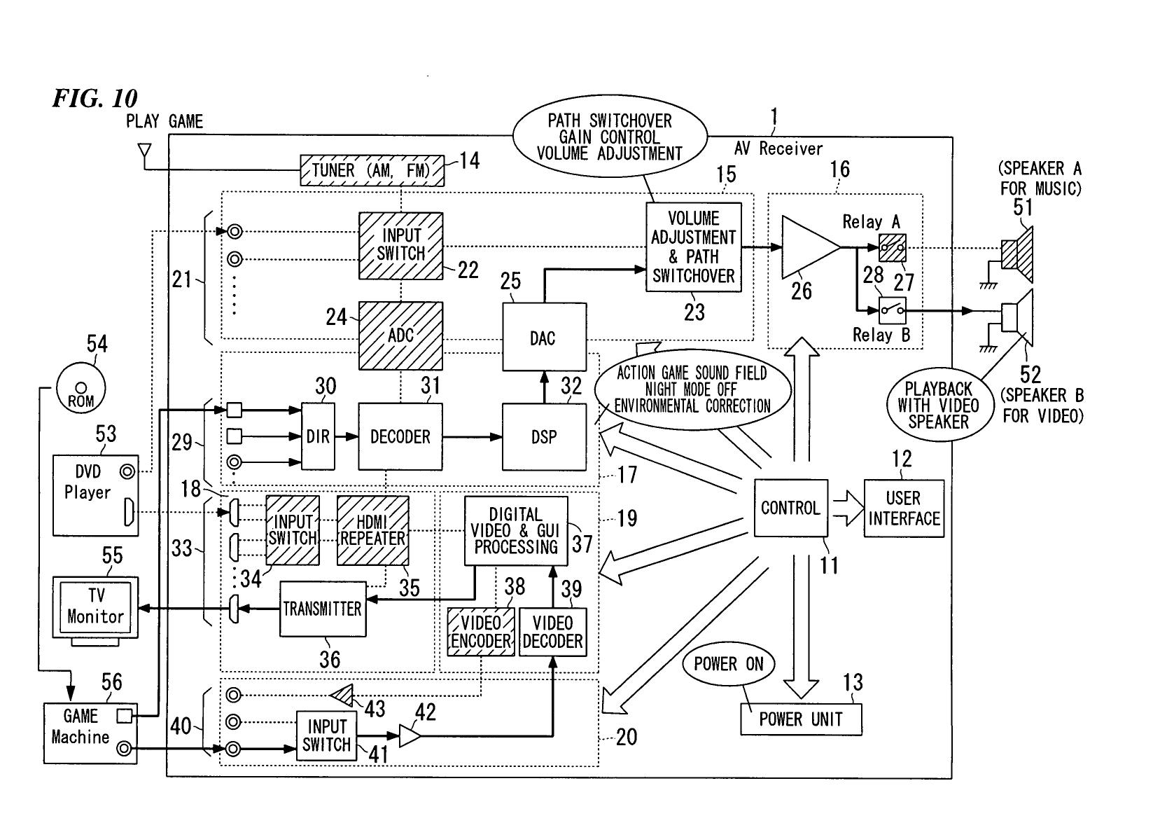

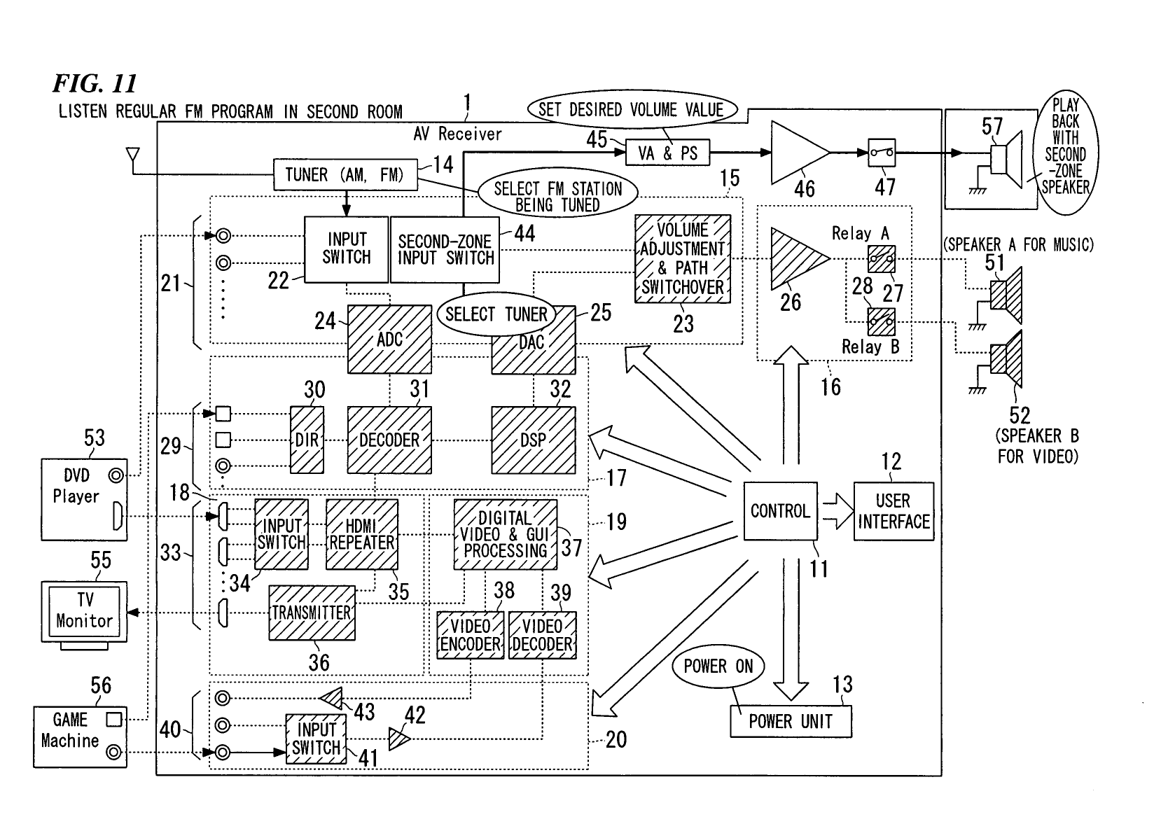

FIG. 11 is a block diagram showing interconnections of blocks in the audio-video receiver 1 for realization of a scene entitled “Listen Regular FM Program In Second Room” when the user presses a scene button 63 (or 73) assigned with a scene template entitled “Listen Regular FM Program In Second Room”. The audio-video receiver 1 shown in FIG. 11 includes a second-zone input switch 44, a second-zone volume adjustment and path switchover section 45, a second-zone power amplifier 46, and a second-zone relay 47, which are not shown in the audio-video receiver 1 shown in FIG. 1, as well as a second-zone speaker 57, which is arranged in a second room such as a kitchen.

In the above, power is turned on with respect to the audio-video receiver 1 and its tuner; a prescribed zone subjected to playback is selected; the tuner is selected; AM/FM is switched over; a broadcasting station is selected; the tuner is selected by means of the second-zone input switch 44; a second-zone volume is set to a desired value; then, the second-zone speaker 57 reproduces sound. In addition, tuning functions are assigned to scan keys (i.e., upward-scan and downward-scan switches) within the operation buttons 74 of the remote control device 71.

Thus, it is possible for the user to reproduce an FM broadcasting program by means of the second-zone speaker 57 by simply pressing the corresponding scene button 63 (or 73).

It is possible to assign different scene data suited to different zones to a single scene button 63 (or 73). This makes it possible to call plural scene data by selecting the corresponding scene button 63 (or 73).

### 2. Simple Scene Assign

Next, the process for changing assignment of scene templates assigned to the scene buttons 63 (or 73) in the mode 83 of SCENE CHANGE shown in FIG. 4 will be described.

The four scene buttons 63 (or 73) are assigned with scene templates having high frequencies in usage in advance, wherein if preset scene templates do not include a desired scene template, the audio-video receiver 1 allows the user to select it from among numerous “preinstalled” scene templates so as to change the preset scene template with it with respect to a desired scene button 63 (or 73).

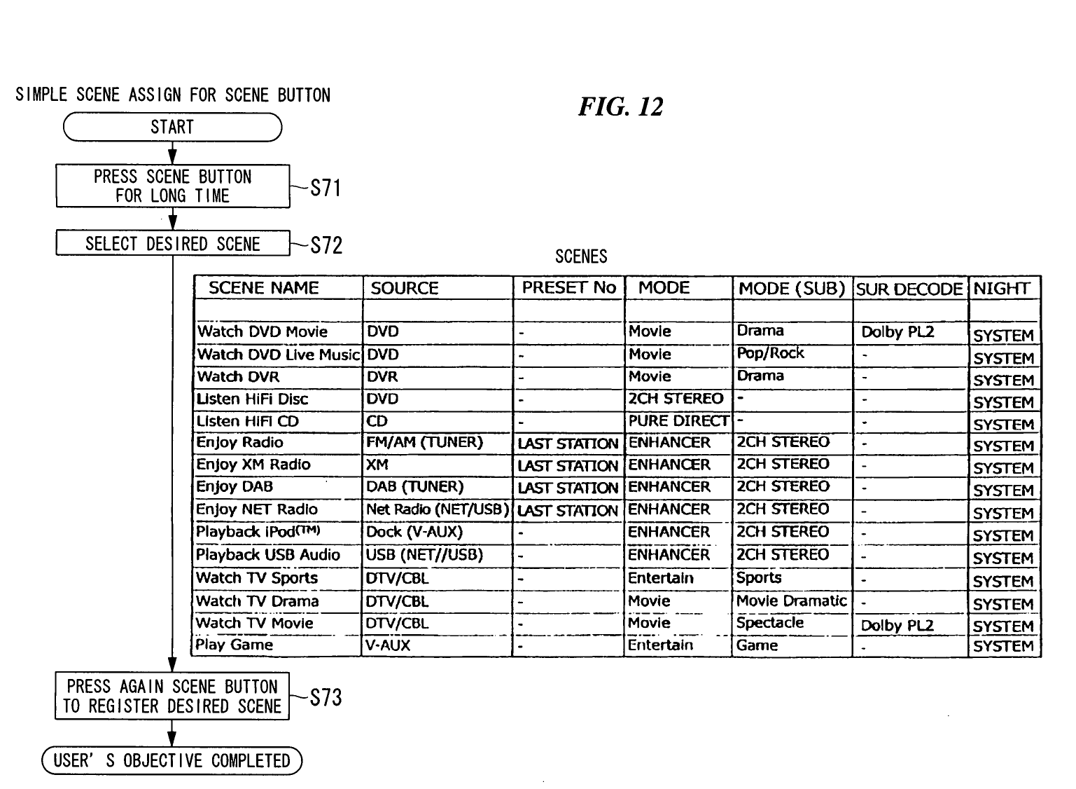

FIG. 12 is a flowchart showing the processing of SIMPLE SCENE ASSIGN.

When the user continuously presses the scene button 63 (or 73) for a long time, transition occurs from the mode 82 to the mode 83 of SCENE CHANGE in step S71.

In the mode 83, the user controls the input selector 64 of the audio-video receiver 1 shown in FIG. 2 (or left-scan and right-scan keys within the operation buttons 74 of the remote control device 71 shown in FIG. 3) so as to select a desired scene template to be assigned to the scene button 63 (or 73) from among numerous scene templates stored in the ROM of the control section 11 in step S72.

FIG. 12 includes a table showing examples of scene templates preinstalled in the audio-video receiver 1. In addition, other scene templates are also stored in the ROM of the control section 11 in advance. In the table, the term “LAST STATION” indicates a previously set value being used again; and the term “SYSTEM” indicates that the control section 11 operates in accordance with the present setup.

Since numerous scene templates, which the user wishes to realize, are preinstalled in the audio-video receiver 1, the user is capable of easily assigning desired scene templates to the scene buttons 63 (or 73) by simply selecting desired scenes. For this reason, it is unnecessary for a large number of users to customize setups and operations in the audio-video receiver 1; hence, it is unnecessary for them to learn specifics of the audio-video receiver 1 such as details of setups and operations.

Recently, the DVD player 53 is designed to play back four media such as DVD-Audio, SACD, CD, and DVD, wherein these media store various contents such as movies and music. For this reason, there is a problem for the user to appropriately select sound fields in playback of different media. As described above, numerous scene templates suited to various occasions and various media are preinstalled in the audio-video receiver 1 of the present embodiment, which is thus designed to solve the aforementioned problem.

After selecting a desired scene template from among numerous scene templates, the user presses again a desired scene button 63 (or 73), which is thus assigned with the desired scene template in step S73.

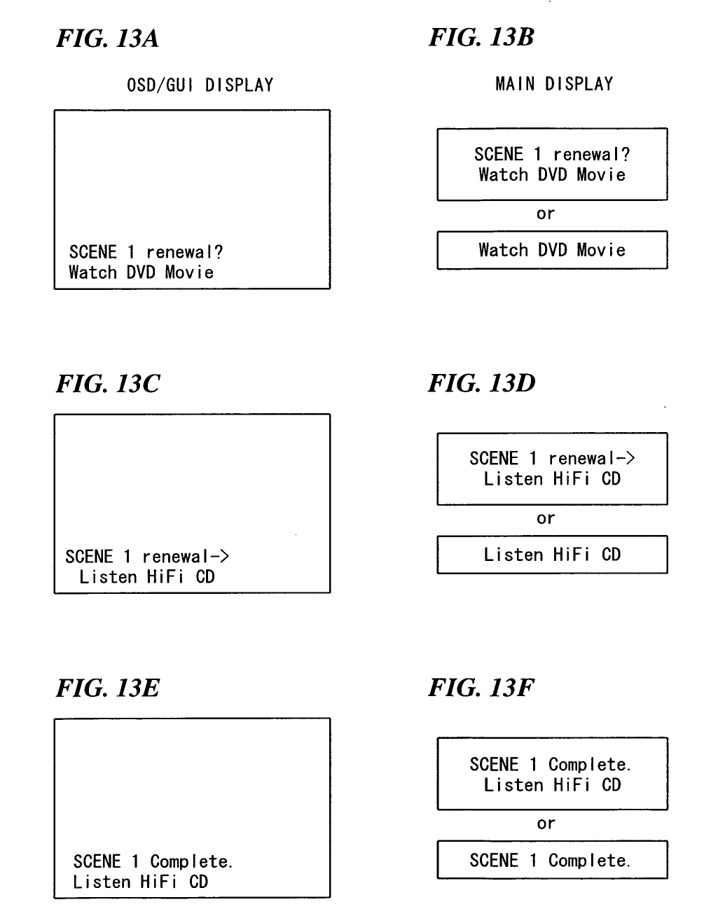

FIGS. 13A to 13F show examples of messages, which are displayed in the mode 83 of SCENE CHANGE by way of the OSP/GUI display and the main display 66.

Suppose that the user continuously presses the scene button 63 (or 73) (herein, referred to as the scene button “1”) for a long time so as to set the mode 83 of SCENE CHANGE. In this case, as shown in FIG. 13A, a message of “SCENE 1 renewal?” indicating that the control section 11 waits for a change of the scene template preset to the scene button “1” in advance as well as a message of “Watch DVD Movie” indicating the scene name of the scene template presently assigned to the scene button “1” are displayed on the TV monitor 55 by way of the OSD/GUI display. In addition, as shown in FIG. 13B, both the aforementioned messages are displayed on the main display 66, or only the message of “Watch DVD Movie” is displayed on the main display 66.

In the aforementioned state, when the user presses the input selection switch 72 (or the arrow key arranged in the operation buttons 74) of the remote control device 71, or when the user operates the input selector 64 of the audio-video receiver 1, prescribed scene templates, which are preinstalled in the audio-video receiver 1, are sequentially called and read out, so that messages shown in FIG. 13C are displayed on the TV monitor 55, and messages shown in FIG. 13D are displayed on the main display 66.

Suppose that the user selects a desired scene template whose scene name is referred to as “Listen HiFi CD” as shown in FIGS. 13C and 13D. In this case, when the user continuously presses the scene button “1” (regarding “SCENE 1”) for a prescribed time (e.g., five seconds), the control section 11 stores the information regarding the desired scene template in the memory, thus entering the change of the scene template with regard to the scene button “1”. Then, messages shown in FIG. 13E are displayed on the TV monitor 55, and messages shown in FIG. 13F are displayed on the main display 66. After completion of the mode 83 as described above, the control section 11 is returned to the mode 82 of SCENE CALL.

Since the audio-video receiver 1 stores numerous scene templates in advance, it is unnecessary for a large number of users to customize various functions and setups, wherein the user is simply required to specifically select scene templates to be assigned to the scene buttons “1” to “4”. In other words, it is unnecessary for the user to learn unnecessary functions of the audio-video receiver 1, whereby the user is capable of appropriately using the audio-video receiver 1 in accordance with the optimum setups and functions suited to the user's objective.

Scent templates preinstalled in the audio-video receiver 1 are determined to suit the users' objectives (or users' usages), wherein the audio-video receiver 1 has numerous libraries with respect to various input sources with regard to audio and video contents. That is, the audio-video receiver 1 is designed to present selections of scenes, which are suited to the user's objective (or user's usage) and which can be recognized by the user immediately.

The manufacturer appropriately selects and setup parameters required for the realization of scenes in relation to scene templates, which are preinstalled in the audio-video receiver 1; hence, the audio-video receiver 1 is not designed to require the user to change unnecessary setups, unnecessary functions, and unnecessary operations.

### 3. Detailed Scene Customization

Next, the processing of DETAILED SCENE CUSTOMIZATION will be described in connection with the mode 84 of SCENE CUSTOMIZATION shown in FIG. 4. When scene templates representing scenes suited to the user's preference are not found in scene templates preinstalled in the audio-video receiver 1, or when the user wishes to partially change preinstalled scene templates, the audio-video receiver 1 allows the user to edit numerous preinstalled scene templates, that is, it allows the user to register new scene data with the scene buttons 63 (or 73).

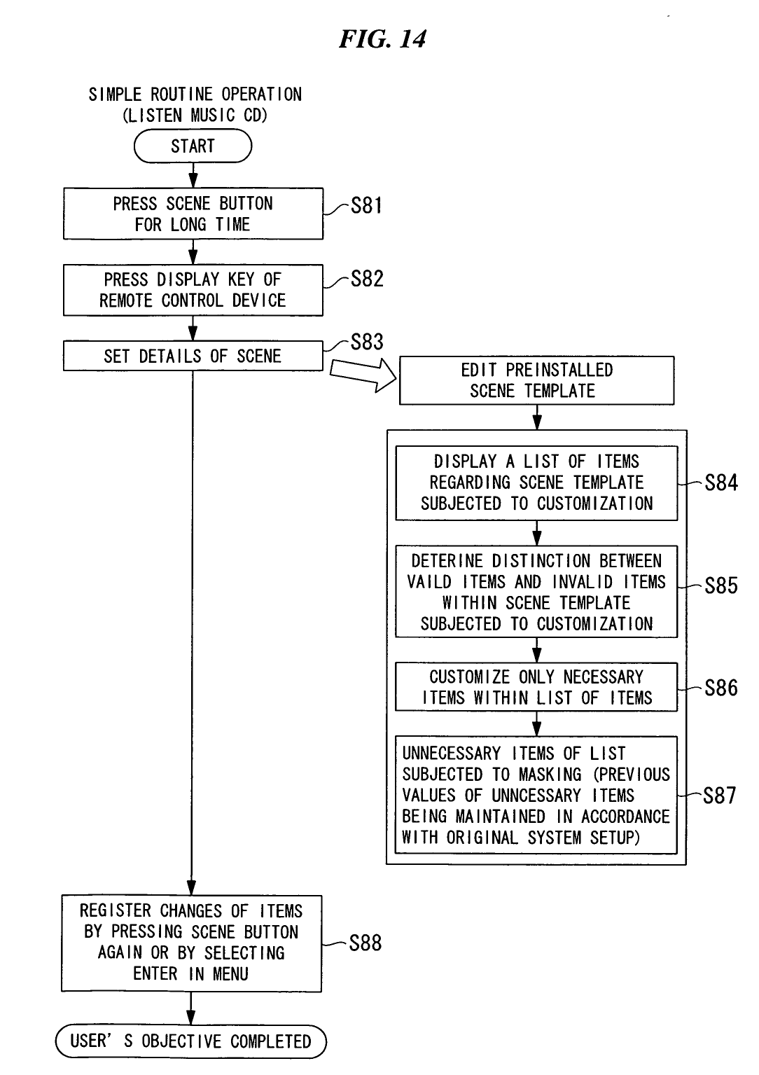

FIG. 14 is a flowchart showing the process of DETAILED SCENE CUSTOMIZATION.

When the user continuously presses the scene button 63 (or 73) for a long time, transition occurs from the mode 82 to the mode 83 in step S81. Then, when the user presses a prescribed key (e.g., a DISPLAY key) of the remote control device 71, transition occurs from the mode 83 to the mode 84 of SCENE CUSTOMIZATION in step S82.

In the mode 84 of SCENE CUSTOMIZATION, the user operates certain keys of the remote control device 71 so as to select scene templates subjected to customization, thus setting up details regarding scenes corresponding to the selected scene templates, in step S83. Details of editing of selected scene templates will be described by way of steps S84 to S87.

Specifically, similar to the foregoing processing of SIMPLE SCENE ASSIGN, the user selects a scene template subjected to customization so as to display items, functions, and setups of the selected scene template on the display screen in step S84. In step S85, the control section 11 determines distinctions between “valid” items and “invalid” items within functions subjected to customization in step S85. In other words, the control section 11 distinguishes between valid items and invalid items with respect to the selected scene, so that a list of only the valid items subjected to customization is displayed. Next, the user customizes only the necessary items within the items of the list being displayed in step S86, whereas unnecessary items are subjected to masking (i.e., their previous setup values are maintained in accordance with the original system setup) in step S87. After completion of setup of details of the selected scene, the user presses again a desired scene button 63 (or 73), or the user selects an ENTER button in MENU (not shown), thus registering the changed contents of the selected scene with the memory in step S88. Details of registration will be described later.

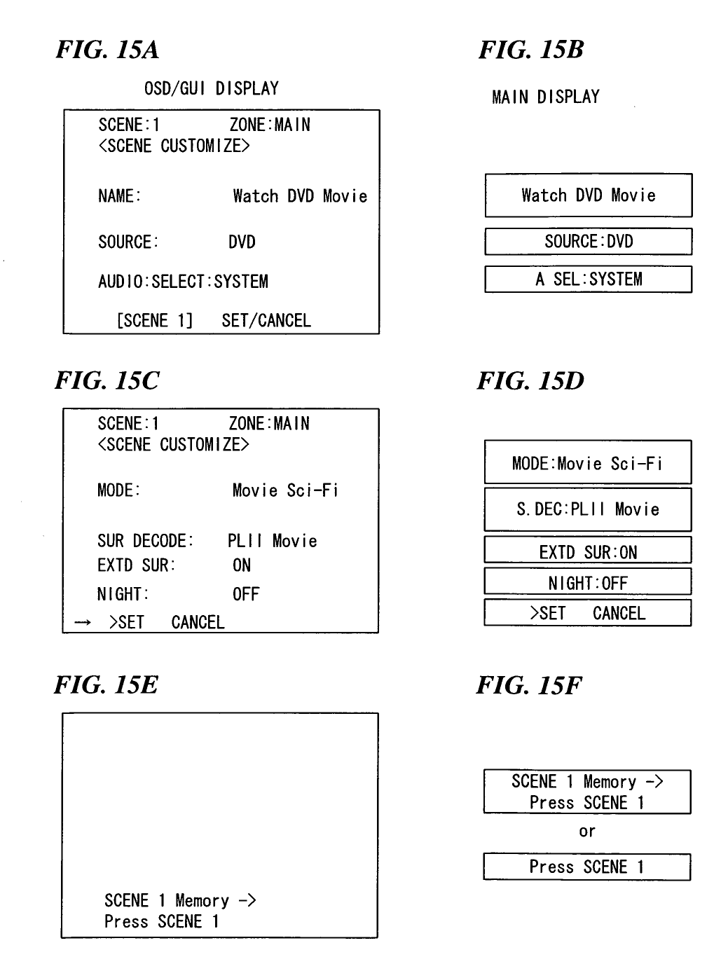

FIGS. 15A to 15F show examples of messages displayed on the TV monitor by way of the OSD/GUI display or on the main display 66 of the audio-video receiver 1 in the mode 84 of SCENE CUSTOMIZATION.

As described above, when the user presses a certain key (e.g., a DISPLAY key) of the remote control device 71 so as to set the mode 84 of SCENE CUSTOMIZATION in step S83, prescribed messages regarding the elected scene template are displayed on the TV monitor 55 and the main display 66 of the audio-video receiver 1. Specifically, as shown in FIGS. 15A and 15C, a list of items of the selected scene template entitled “Watch DVD Movie” is displayed on the TV monitor 55 by way of the OSD/GUI display. In this example, two screen displays are used to show the items of the selected scene template subjected to customization. As shown in FIGS. 15B and 15D, the aforementioned items are individually displayed on the main display 66, wherein the user can change the items being displayed on the main screen 66 by operating certain keys of the remote control device 71.

The user selects items that the user wishes to change within the displayed items, thus changing them.

With reference to the messages shown in FIGS. 15A and 15B, which are displayed on the TV device 55 and the main display 66 of the audio-video receiver 1, the user operates a prescribed key (e.g., an ENTER key) of the remote control device 71 so as to sequentially change the items.

Once the ENTER key is pressed, the control section 11 is set to a mode of RENAME (accepting a change of a scene name), wherein the top letter “W” in the scene name “Watch DVD Movie” corresponding to the original scene template blinks; then, the user operates right-scan and left-scan keys to move the designated letter to be edited or changed, or the user operates upward-scan and downward-scan keys to change letters, thus changing the original scene name to a desired scene name.

Next, the user presses the ENTER key again so as to select an input source as the next changed subject, wherein the user operates right-scan and left-scan keys so as to select DVD, CD, DTV, FM/AM, DAB, XM, and MULTI CH as the input source.

In order to change an input mode with reference to AUDIO SELECT, the user operates right-scan and left-scan keys so as to select [SYSTEM], AUTO, HDMI, ANALOG, and DIGITAL as the input mode, wherein the parentheses “[ ]” indicate a default value.

Next, with reference to the messages shown in FIGS. 15C and 15D, the user operates right-scan and left-scan keys so as to select SYSTEM, [SOUND FIELD], STRAIGHT, PureDirect (DirectStereo), and Music Enhancer, thus changing [MODE].

In order to change [SUR DECODE], the user operates right-scan and left-scan keys so as to select [SYSTEM], PL, PLIIMovie, PLIIMusic, Neo:6Cinema, Neo:6Music, Neral, and (CSII).

In order to change [EXTD SUR], the user operates right-scan and left-scan keys so as to select [SYSTEM], AUTO, ON, and OFF.

In order to change NIGHT (indicating the night listening mode), the user operates right-scan and left-scan keys so as to select [SYSTEM], OFF, LOW, MID, and HIGH.

Furthermore, the user operates right-scan and left-scan keys so as to select SET and CANCEL. When SET is selected, setups changed by the user are saved, so that the TV monitor 55 and the main display 66 display prescribed messages, which declare completion of changes of items of the desired scene template as similar to the foregoing messages shown in FIGS. 13E and 13F. Thereafter, transition occurs from the mode 84 of SCENE CUSTOMIZATION to the mode 83 of SCENE CHANGE. When CANCEL is selected, setups changed by the user are not saved; then, transition occurs from the mode 84 to the mode 83. The aforementioned operation designated by selecting SET is performed even when the user continuously presses the corresponding scene button 63 (or 73), instead of selecting SET, for a prescribed time (e.g., five seconds).

Incidentally, when the user presses a wrong scene button, which differs from the “correct” scene button subjected to customization, alert messages shown in FIGS. 15E and 15F are displayed on the TV monitor 55 and the main display 66 of the audio-video receiver 1, thus requesting the user to press the correct scene button.

As described above, the audio-video receiver 1 allows the user to select valid items, which are visually displayed when the original scene template is called and read out. This narrows down all items to valid items, which may be necessarily corrected; hence, the user can easily recognize them. Herein, only the least-minimum number of items is selectable by the user, so that the user can immediately operate the audio-video receiver 1 to appropriately select and change them. Basically, functions, which are valid for the user to listen to a radio, differ from functions, which are valid for the user to watch a movie on a DVD. To cope with such a difficulty, the present embodiment is designed to change necessary functions with respect to scenes respectively, wherein it determines whether or not to visually display each of necessary functions while masking unnecessary items.

Since the present embodiment is designed to display a list of necessary items collectively, it is easy for the user to grasp all the items on screen.

In addition, the present embodiment allows the user to select and customize items in accordance with the present setup; hence, it is unnecessary for the user to call and renew unnecessary items.

Furthermore, the present embodiment allows the user to change scene names subjected to customization; this makes it possible to set easy-to-understand scene names.

The aforementioned description is made such that the user customizes originally preinstalled scene templates; however, when the scene button is already assigned with customized scene data, the user can further create new scene data based on already customized scene data.

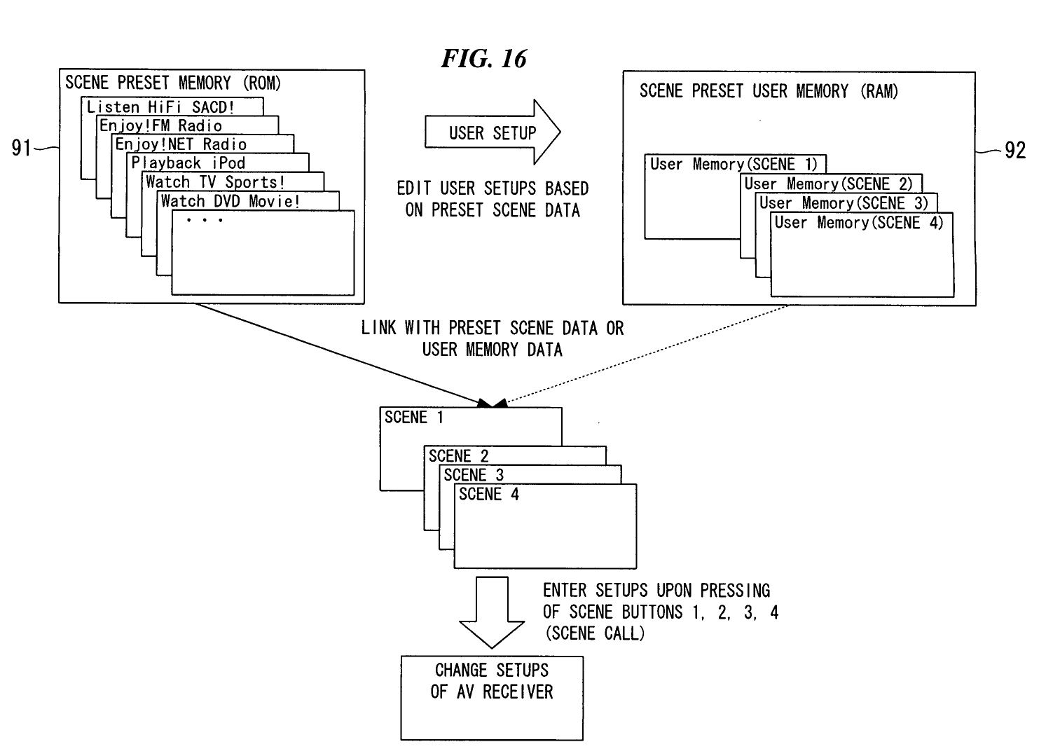

FIG. 16 shows the relationship between preset scene templates and scene data customized by the user.

In FIG. 16, reference numeral 91 designates a scene preset memory arranged in the ROM, which includes numerous storage areas for storing scene templates; and reference numeral 92 designates a scene preset user memory arranged in the RAM, which stores scene data customized by the user in the mode 84 of SCENE CUSTOMIZATION. The scene preset user memory 92 includes four storage areas for storing scene data customized by the user with regard to SCENE 1, SCENE 2, SCENE 3, and SCENE 4. The number of customized scene data stored in the scene preset user memory 92 is not necessarily limited to four; hence, it can be set to an arbitrary integral number such as one or more.

When the user selects an original scene template subjected to customization, the selected scene template is read into a user memory (not shown) suiting to a desired scene button; then, a list of necessary items thereof is displayed and appropriately customized. Then, customized scene data are stored in a prescribed storage area of the scene preset user memory 92.

As described above, with respect to the four scene buttons 63 (or 73), scene templates stored in the scene preset memory 91 and/or data indicating links between the scene preset memory 91 and the scene user preset memory 92 are stored in the RAM. When the user presses a certain scene button, scene data linked to the pressed scene button is read from the scene preset memory 91 or the scene user preset memory 92, so that the control section 11 realizes setups and operations on the basis of setups and operation information included in the scene data.

In FIG. 16, the scene preset user memory 92 is embodied by means of the RAM; but this is not a restriction. That is, the scene preset user memory 92 can be embodied by means of another rewritable memory such as a flash memory.

The present invention is not necessarily limited to the present embodiment, which can be further modified in a variety of ways.

The present embodiment is designed such that, as shown in FIG. 4, different modes 83 and 84 are used to realize SCENE CHANGE and SCENE CUSTOMIZATION. Instead, it is possible to set a single mode for the realization of SCENE CHANGE and SCENE CUSTOMIZATION. Herein, when the user continuously presses a scene button for a prescribed time or more, transition occurs from the mode 82 of SCENE CALL to the aforementioned mode of SCENE CHANGE and SCENE CUSTOMIZATION.

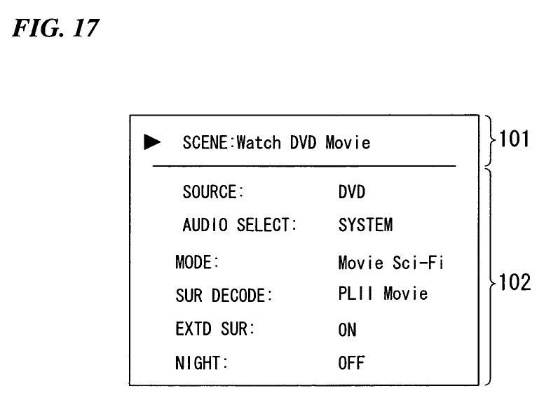

FIG. 17 shows an example of messages that are displayed in the aforementioned mode of SCENE CHANGE and SCENE CUSTOMIZATION by way of the OSD/GUI display.

The overall display area of the OSD/GUI display of FIG. 17 is divided into an area 101 showing the scene name of scene data assigned to the pressed scene button and an area 102 showing items of the scene data. When the control section 11 is set to the mode of SCENE CHANGE and SCENE CUSTOMIZATION, a list of items of scene data assigned to the pressed scene button is displayed by way of the OSD/GUI display.

In order to customize scene data when a certain scene name is displayed and subjected to changing as shown in FIG. 17, the user operates a downward-scan key of the remote control device 71 so as to select each of items belonging to the area 102 as an editing subject. Specifically, the user operates upward-scan and downward-scan keys so as to select an item subjected to editing; then, the user operates right-scan and left-scan keys so as to change the content of the item to desired content. After completion of changing, the user presses the scene button so as to enter the change, so that customized scene data is assigned to the scene button. Thereafter, the control section is returned to the mode 81 of SCENE CALL.

As described above, when transition occurs from the mode 81 of SCENE CALL to the mode of SCENE CHANGE and SCENE CUSTOMIZATION, a list of items of scene data, which are assigned to the scene button being pressed by the user, is displayed by way of the OSD/GUI display. This is a simple operation compared with the aforementioned operation (see FIG. 4) using different modes 83 and 84 for realization of SCENE CHANGE and SCENE CUSTOMIZATION.

The present embodiment is designed to allow the user to select scenes by use of the scene buttons 63 of the audio-video receiver 1 and the scene buttons 73 of the remote control device 1; but this is not a restriction. Instead of using buttons and keys, it is possible to use a touch panel allowing the user to select scenes.

Alternatively, it is possible to introduce another external control device other than the remote control device 71. For example, when the audio-video receiver 1 is interconnected to a network, it is possible for the user to access the audio-video receiver 1 in accordance with a web browser program by means of a personal computer connected to the network, thus allowing the user to select and edit scenes on the computer screen which runs in accordance with the web browser program.

The present invention is not necessarily limited to the audio-video receiver 1 but is applicable to any types of devices such as audio-video amplifies, each of which is connected to plural input sources so as to perform plural types of signal processing on input signals, thus outputting processing results.

Lastly, the present invention is not necessarily limited to the present embodiment, which can be further modified in a variety of ways within the scope of the invention defined by the appended claims.

What is claimed is:

1. An audio-video apparatus, which is connectable to a plurality of external devices so as to process input signals and to thereby control the plurality of external devices individually, comprising:
a memory for storing a plurality of packaged information, each of which includes information regarding setup and operation in connection with each of the plurality of external devices;
a selector for selecting desired packaged information from among the plurality of packaged information stored in the memory; and
a control section for controlling at least one of the plurality of external devices based on the desired packaged information, which is selected by the selector.

2. An audio-video apparatus according to claim 1, wherein the selector is constituted of a plurality of manual operable members, each of which is assigned with the packaged information that has a high frequency in usage in advance, and wherein the control section allows a user to customize the packaged information preset to each of the manual operable members.

3. An audio-video apparatus according to claim 2 further comprising a second memory for storing new packaged information, which is produced by editing the packaged information stored in the memory by the user, so that each of the manual operable members is assigned with the new packaged information instead of the packaged information previously assigned thereto.

4. An audio-video apparatus, which is connectable to a plurality of external devices so as to process input signals and to thereby control the plurality of external devices individually, comprising:
a signal processor for processing input signals supplied from a desired external device within the plurality of external devices;
an input switch for switching and selecting the desired external device from among the plurality of external devices;
a memory for storing a plurality of scene templates, each of which includes information regarding setup and operation in connection with each of the plurality of external devices;
a plurality of scene buttons, which are assigned with the plurality of scene templates in advance; and
a control section for controlling the signal processor and the input switch in such a way that, when a user operates a desired scene button within the plurality of scene buttons, a scene template assigned to the desired scene button is applied to the input signal supplied from the desired external device.

5. An audio-video apparatus according to claim 4 further comprising a display for displaying a message under control of the control section, wherein the control section allows the user to edit and customize the scene template preset to the desired scene button with reference to the message indicating details of the scene template.

6. An audio-video apparatus according to claim 4, wherein each of the plurality of scene templates is configured by a plurality of items with regard to a prescribed scene to be realized in connection with each of the plurality of external devices, so that the control section allows the user to selectively change the plurality of items so as to customize the scene template.
